(19) United States
(12) Patent Application Publication
(10) Pub. No.: US 2017/0339140 A1
(43) Pub. Date: Nov. 23, 2017

(54) BIOMETRIC AUTHENTICATION SYSTEM AND METHOD

(71) Applicants: Barry Corel Sudduth, Central, SC (US); Robert Barger Hanson, Mobile, AL (US)

(72) Inventors: Barry Corel Sudduth, Central, SC (US); Robert Barger Hanson, Mobile, AL (US)

(21) Appl. No.: 15/599,384

(22) Filed: May 18, 2017

Related U.S. Application Data
(60) Provisional application No. 62/338,402, filed on May 18, 2016.

(51) Int. Cl. H04L 29/06; G06F 19/00; H04W 12/06

(52) U.S. Cl. CPC H04L 63/0861; H04W 12/06; G06F 19/322; H04L 63/0853

(57) ABSTRACT

A biometric authentication system and method are provided. Desired information is stored within a management system. Access to information stored within the management system is limited based upon an identity system linked to the management system verifying user identity and the scanning of an access code generated by the identity system. User identity is verified by storing biometric data acquired from a user, acquiring a biometric sample from a user, and comparing the biometric data to establish a match therebetween. A computing device having certain features, such as a touch ID sensor and camera, may be utilized to acquire biometric samples and scan the generated access code. Upon the identity system verifying a requesting user's identity and determining the access code has been properly scanned, the management system may output certain information stored therein to the requesting user.

### CROSS-REFERENCE TO RELATED APPLICATIONS

This application claims priority to U.S. Provisional Patent Application No. 62/338,402, entitled “A patient authentication system for health data exchange in home environments”, filed May 18, 2016, which application is incorporated herein in its entirety.

### FIELD OF THE DISCLOSURE

The subject matter of the present disclosure refers generally to a biometric authentication system and method.

### BACKGROUND

Due to the convenience and immediate access afforded by digital storage, sensitive personal and commercial information is now commonly stored as digital data within various digital systems. Traditionally, such systems have attempted to protect the information stored therein by associating the information with user accounts and limiting access to such accounts via login names and passwords. Under this framework, access to the information associated with a user account is granted upon entering the login name and password associated with that user account and the system verifying the same. However, because such login names and passwords generally employed by known data-storage systems are text-based (alphabetic, numeric, symbolic, and/or combinations thereof), such systems are unable to verify that the individual inputting the login name and password is actually the individual associated with that user account. Accordingly, known data-storage systems generally do not authenticate user identity, but rather, merely verify that a login name and password tied to an account within the system has been entered. Thus, all information associated with a user's account in such systems is readily accessible by anyone possessing the login name and password associated with that account.

Moreover, there are numerous instances and applications wherein it is critical to ensure that a specific individual accesses important information. For instance, informational data is commonly exchanged between healthcare providers and patients. It is important to know that educational and compliance information assigned by a healthcare provider has been accessed by the patient and/or the patient's caregiver to ensure the nature of the patient's condition and any treatment regimen associated therewith is clearly understood. Due to reliance upon text-based login names and passwords, known data-storage systems are generally unable to identify that a specific user has accessed a defined piece of information. Thus, known-data storage systems are often insufficient for many applications that necessitate secure transmission of medical information.

Furthermore, by limiting user access to system information based on a login name and password framework, the degree of security provided by such systems is often proportional to the degree of care a user takes in protecting their login name and password. This framework not only shifts the burden of protecting system information to the user, but also frequently leads to user credentials becoming compromised, often through means unbeknownst to the user. A user's login name and password may become compromised in a variety of ways including, but not limited to, storing such credentials on a public computer or network, low-strength login name/password combination, or having such credentials stolen.

Accordingly, there is a need in the art for a system and method for limiting information access based on user identity verification. Moreover, there is a need in the art for a system and method capable of identifying when a specific individual has accessed a defined piece of information. Additionally, there is a need in the art for a system and method that achieves these ends and does not shift the burden of securing system information to users.

### SUMMARY

A biometric authentication method and system are provided. Generally, the system and method of the present disclosure are designed to securely store information and limit user access to such information based, at least in part, on the biometric data associated with users. Desired information is stored within a management system and tied to a user account associated with a defined user within the management system. In a preferred embodiment, the management system is a patient health information management system configured to store patient and/or physician information with patient accounts and/or physician accounts, respectively, therein. An identity system configured to verify user identity is operably connected to the management system such that information may be transmitted therebetween. User accounts are created within the identity system such that each user account corresponds to a defined user and has information relating to the defined user tied thereto. Each user account within the identity system is linked to a user account within the management system by one or more shared data elements between the respective accounts. In some instances, user accounts may only be created within the identity system for users who have pre-registered with the entity responsible for managing the management system.

In a preferred embodiment, users may request access to information stored within the management system by transmitting a user request to the management system via a first computing device operably connected to the management system. Before the requesting user may access information stored within the management system, the user's identity is verified. In one preferred embodiment, user identity is verified by a second computing device, such as a mobile telephone, storing biometric data acquired from a user, obtaining a biometric sample from a user, and subsequently comparing the biometric sample to the stored biometric data to establish a match therebetween. In a preferred embodiment, the foregoing biometric authentication is used to authenticate a user badge containing information relating to a user's identity on the second computing device. Once authenticated, the user badge or information associated therewith is transmitted to the identity system, where the identity system determines if the transmitted information corresponds to information tied to a user account within the identity system. If such information does correspond, the identity system signals that the user is authorized.

In another embodiment, the biometric data acquired form a user may be stored within the identity system and tied to a user account therein. In such embodiments the biometric sample provided to the second computing device is transmitted to the identity system to determine whether the supplied sample matches biometric data tied to a user account therein. Upon matching the biometric sample to the biometric data tied to a user account, the identity system signals that the user is authorized. Accordingly, by verifying user identity via biometric authentication in at least one of the foregoing manners, the system and method of the present disclosure link identity to a user request. In this way, the system and method of the present disclosure ensures only users actually associated with an account within the management system are authorized to access information tied thereto.

Upon receiving a user request for information, the management system may prompt the identity system to generate an access code. Once generated the access code is subsequently transmitted to the first computing device on which the request for information was made. Utilizing a camera function of the second computing device, within a mobile application or otherwise, the user scans the displayed access code, thereby creating a scanned code. The scanned code is transmitted to the identity system to determine if the scanned code matches the access code transmitted to the first computing device. Upon the identity system determining a match between such codes and verifying user identity, the identity system informs the management system that the requesting user is authorized to access the requested information. The management system subsequently retrieves information associated with the requesting user and outputs the same. In one preferred embodiment, the management system may generate a report indicating that a user has accessed a specific piece of information stored therein. Because the system and method of the present disclosure grants or denies access largely based upon biometric data and internally generated access codes, users are generally not required to remember login names and/or passwords and are not charged with safeguarding such information.

In a preferred embodiment, the management system comprises a management database configured to store information therein and a management server configured to retrieve and transmit information stored within the management database. The identity system preferably comprises an identity database configured to store user accounts corresponding to individual users therein. In a preferred embodiment, the identity database may further store the biometric data of a user therein. The identity system further comprises an identity server configured to verify user identity. The management server and identity server may have a first and second non-transitory computer-readable medium, respectively, attached thereto. The first non-transitory computer-readable medium has instructions stored thereon, which, when executed by the management server, cause the management server to perform certain operations disclosed herein. The second non-transitory computer-readable medium has instructions stored thereon, which, when executed by the identity server, cause the identity server to perform certain operations disclosed herein.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is an exemplary diagram of a client of FIG. 1 according to an implementation consistent with the principles of the present disclosure.

FIG. 3 is a diagram of an example computing device and mobile computing device.

FIG. 4 is a diagram of a system embodying features consistent with the principles of the present disclosure.

FIG. 5 is a flow chart illustrating certain method steps of a method for limiting information access based on biometric authentication consistent with the principles of the present disclosure.

FIG. 6 shows a user accessing a user account in a manner consistent with the principles of the present disclosure.

FIG. 7 shows a user capturing an access code displayed on a first computing device via a second computing device in a manner consistent with the principles of the present disclosure.

FIG. 8 provides an example webpage displaying information in a manner consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “created vector” and grammatical equivalents refers to the one or more vectors created by the processor based on the mapped activation levels of the one or more sensors.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As will be evident from the disclosure provided below, the subject matter of the present disclosure satisfies the need for a system and method for limiting information access based on user identity verification, thereby improving upon known systems currently employed within the art.

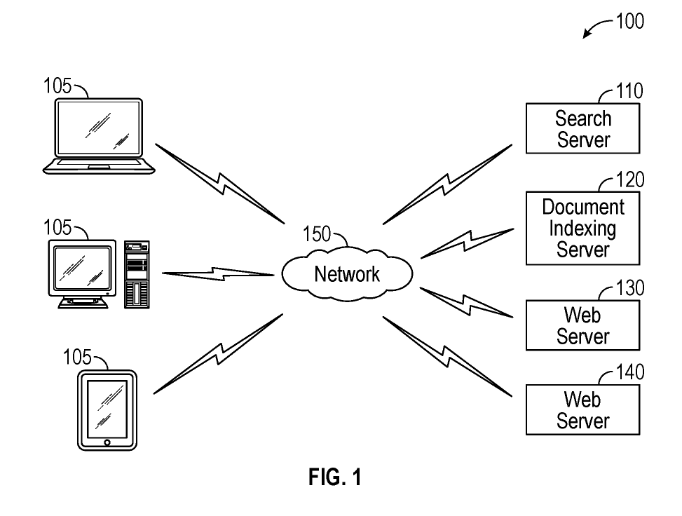

FIG. 1 is a diagram of an example environment 100 in which techniques described herein may be implemented. Environment 100 may include multiple clients 105 connected to one or more servers 110-140 via a network 150. In some implementations, and as illustrated, server 110 may be a search server, that may implement a search engine; and server 120 may be a document indexing server, e.g., a web crawler; and servers 130 and 140 may be general web servers, such as servers that provide content to clients 105. Clients 105 and servers 110-140 may be connected to network 150 via wired, wireless, or a combination of wired and wireless connections.

Three clients 105 and four servers 110-140 are illustrated as connected to network 150 for simplicity. In practice, there may be additional or fewer clients and servers. Also, in some instances, a client may perform the functions of a server and a server may perform the functions of a client.

Clients 105 may include devices of users that access servers 110-140. A client 105 may include, for instance, a personal computer, a wireless telephone, a personal digital assistant (PDA), a laptop, a smart phone, a tablet computer, or another type of computation or communication device. Servers 110-140 may include devices that access, fetch, aggregate, process, search, provide, and/or maintain documents. Although shown as single components 110, 120, 130, and 140 in FIG. 1, each server 110-140 may, in some implementations, be implemented as multiple computing devices, which potentially may be geographically distributed.

Search server 110 may include one or more computing devices designed to implement a search engine, such as a documents/records search engine, general webpage search engine, etc. Search server 110 may, for example, include one or more web servers to receive search queries and/or inputs from clients 105, search one or more databases in response to the search queries and/or inputs, and provide documents or information, relevant to the search queries and/or inputs, to clients 105. In some implementations, search server 110 may include a web search server that may provide webpages to clients 105, where a provided webpage may include a reference to a web server, such as one of web servers 130 or 140, at which the desired information and/or links is located. The references, to the web server at which the desired information is located, may be included in a frame and/or text box, or as a link to the desired information/document.

Document indexing server 120 may include one or more computing devices designed to index documents available through network 150. Document indexing server 120 may access other servers, such as web servers that host content, to index the content. In some implementations, document indexing server 120 may index documents/records stored by other servers, such as web servers 130 and 140 and, connected to network 150. Document indexing server 120 may, for example, store and index content, information, and documents relating to user accounts and user-generated content.

Web servers 130 and 140 may each include web servers that provide webpages to clients. The webpages may be, for example, HTML-based webpages. A web server 130/140 may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

While servers 110-140 are shown as separate entities, it may be possible for one or more servers 110-140 to perform one or more of the functions of another one or more of servers 110-140. For example, it may be possible that two or more of servers 110-140 are implemented as a single server. It may also be possible for one of servers 110-140 to be implemented as multiple, possibly distributed, computing devices.

Network 150 may include one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks.

Although FIG. 1 shows example components of environment 100, in other implementations, environment 100 may contain fewer components, different components, differently arranged components, and/or additional components than those depicted in FIG. 1. Alternatively, or additionally, one or more components of environment 100 may perform one or more other tasks described as being performed by one or more other components of environment 200.

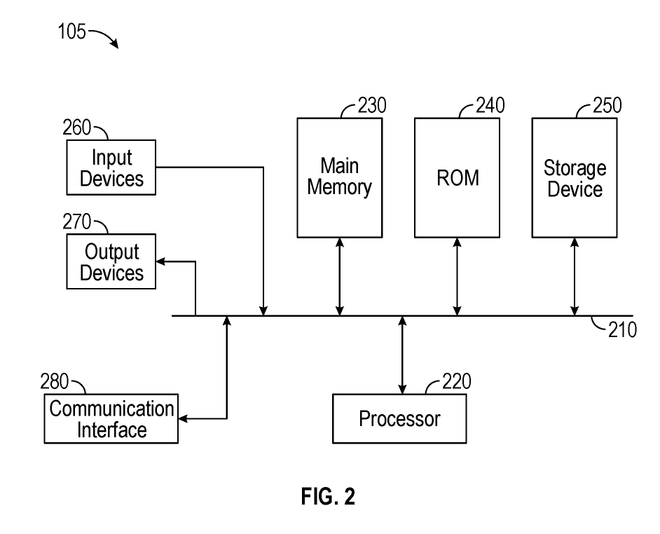

FIG. 2 is an exemplary diagram of a user/client 105 or server entity (hereinafter called “client/server entity”), which may correspond to one or more of the clients and servers, according to an implementation consistent with the principles of the invention. The client/server entity 105 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity 105.

Processor 220 may include any type of conventional processor or microprocessor that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity 105, such as a scanner, phone, camera, scanning device, keyboard, a mouse, a pen, voice recognition and/or biometric mechanisms, etc. Output device(s) 270 may include one or more conventional mechanisms that output information to the operator, including a display, a printer, a speaker, an alarm, a projector, etc. Communication interface 280 may include any transceiver-like mechanism that enables the client/server entity 105 to communicate with other devices 105 and/or systems. For example, communication interface 280 may include mechanisms for communicating with another device 105 or system via a network, such as network 150.

As will be described in detail below, the client/server entity 105, consistent with the principles of the invention, performs certain receiving, communicating, generating, output providing, correlating, and storing operations. The client/server entity 105 may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as read-only memory (ROM), random access memory (RAM), flash memory, and the like. The software instructions contained in memory 230 causes processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

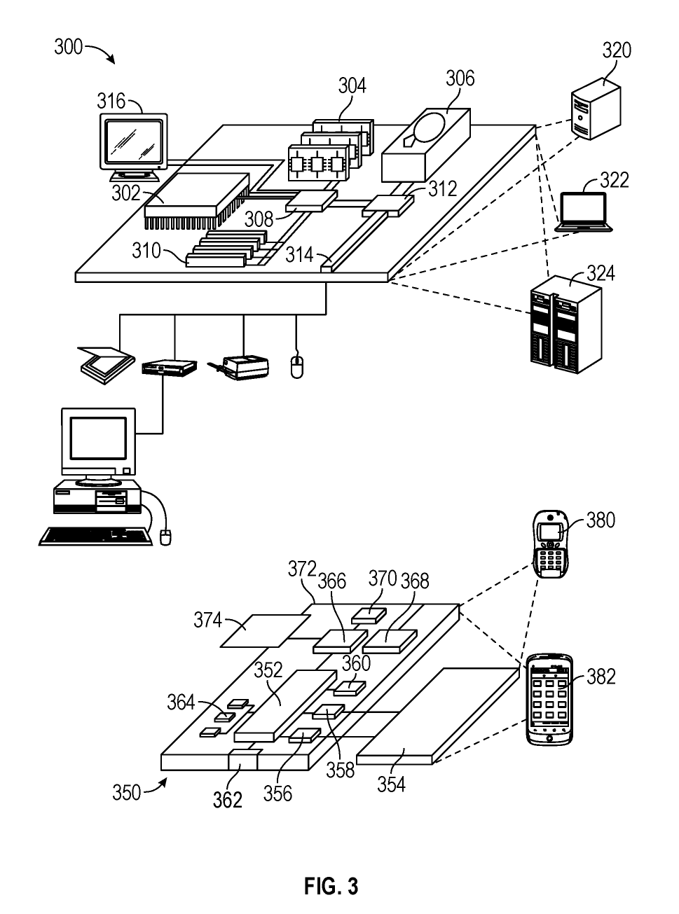

FIG. 3 is a diagram of an example of a computing device 300 and a mobile computing device 350, which may be used with the techniques described here. Computing device 300 or mobile computing device 350 may correspond to, for example, a client 205 and or a server 210-240. Computing device 300 is intended to represent various forms of digital computers, such as laptops, desktops, workstations, personal digital assistants, servers, mainframes, and other appropriate computers. Mobile computing device 350 is intended to represent various forms of mobile devices, such as scanners, scanning devices, personal digital assistants, cellular telephones, smart phones, tablet computers, and other similar computing devices. The components show in FIG. 3, their connections and relationships, and their functions, are meant to be examples only, and are not meant to limit implementations described herein.

Computing device 300 may include a processor 302, a memory 304, a storage device 306, a high-speed interface 308 connecting to a memory 304 and high-speed expansion ports 310, and a low-speed interface 312 connecting to a low-speed expansion port 314 and a storage device 306. Each of components 302, 304, 306, 308, 310, 312, and 314 are interconnected using various buses, and may be mounted on a common motherboard or in other manners as appropriate. Processor 302 can process instructions for execution within computing device 300, including instructions stored in memory 304 or on storage device 306 to display graphical information for a graphical user interface (GUI) on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations, as a server bank, a group of blade servers, or a multi-processor system, etc.

Memory 304 stores information within computing device 300. In some implementations, memory 304 includes a volatile memory unit or units. In another implementation, memory 304 may include a non-volatile memory unit or units. Memory 304 may also be another form of computer-readable medium, such as a magnetic or optical disk. A computer-readable medium may refer to a non-transitory memory device. A memory device may refer to storage space within a single storage device or spread across multiple storage devices.

Storage device 306 is capable of providing mass storage for computing device 300. In some implementations, storage device 306 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or a memory on processor 302.

High-speed interface 308 manages bandwidth-intensive operations for computing device 300, while low-speed interface 312 manages lower bandwidth-intensive operations. Such allocation of functions is an example only. In some implementations, high-speed interface 308 is coupled to memory 304, display 316, such as through a graphics processor or accelerator, and to high-speed expansion ports 310, which may accept various expansion cards. In this implementation, low-speed interface 312 may be coupled to storage device 306 and low-speed expansion port 314. Low-speed expansion port 314, which may include various communication ports, such as USB, Bluetooth, Ethernet, wireless Ethernet, etc., may be coupled to one or more input/output devices, such as a keyboard, a pointing device, a scanner, or a networking device such as switch or router, e.g., through a network adapter.

Computing device 300 may be implemented in a number of different forms, as shown in the figures. For example, computing device 300 may be implemented as a standard server 320, or in a group of such servers. Computing device 300 may also be implemented as part of a rack server system 324. In addition, computing device 300 may be implemented in a personal computer, such as a laptop computer 322. Alternatively, components from computing device 300 may be combined with other components in a mobile device, such as mobile computing device 350. Each of such devices may contain one or more computing devices 300, 350, and an entire system may be made up of multiple computing devices 300, 350 communicating with each other.

Mobile computing device 350 may include a processor 352, a memory 364, an input/output (“I/O”) device, such as a display 354, a communication interface 366, and a transceiver 368, among other components. Mobile computing device 350 may also be provided with a storage device, such as a micro-drive or other device, to provide additional storage. Each of the components 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a TFT LCD (Thin-Film-Transistor Liquid Crystal Display) or an OLED (Organic Light Emitting Diode) display or other appropriate display technology. Display interface 356 may include appropriate circuitry for driving display 354 to present graphical and other information to a user. Control interface 358 may receive commands from a user and convert the commands for submission to processor 352. In addition, an external interface 362 may be provided in communication with processor 352, so as to enable near area communication of mobile computing device 350 with other devices. External interface 362 may provide, for example, for wired communications in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for device 350, or may also store applications or other information for mobile computing device 350. Specifically, expansion memory 374 may include instructions to carry out or supplement the processes described herein, and may include secure information also. Thus, for example, expansion memory 374 may be provided as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described herein. The information carrier is a computer-or machine readable-medium, such as memory 364, expansion memory 374, or a memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS or MMS messaging, CDMA, TDMA, PDC, WCDMA, CDMA2000, or GPRS, among others. Such communication may occur, for example, through transceiver 368. In addition, short-range communication may occur, such as using a Bluetooth, WiFi, or other such transceiver. In addition, GPS (Global Positioning System) received module 370 may provide additional navigation-and location-related wireless data to mobile computing device 350, which may be used as appropriate by applications running on mobile computing device 350.

Mobile computing device 350 may also communicate audibly using audio codec 360, which may receive spoken information from a user and covert the received spoken information to digital information. Audio codec 360 may likewise generate audible sound for a user, such as through a speaker, e.g., in a handset of mobile computing device 350. Such sound may include sound from voice telephone calls, may include recorded sound, such as voice messages, music files, etc., and may also include sound generated by applications operating on mobile computing device 350.

Mobile computing device 350 may be implemented in a number of different forms, as shown in the figure. For example, mobile computing device 350 may be implemented as a cellular telephone 380. Mobile computing device 350 may also be implemented as part of a smart phone 382, personal digital assistant, or other similar mobile device.

Various implementations described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The contents of computer-readable medium may physically reside in one or more memory devices accessible by server. Computer-readable medium may include a database of entries corresponding to certain subject matter disclosed herein. A user or organization's information may be provided in information fields and stored in a database, as set forth herein. Said fields are customizable and may include additional or alternative fields based on the user's needs. Said information is accessible through the server.

To provide for interaction with a user, the techniques described herein can be implemented on a computer having a display device, such as a CRT (cathode ray tube), LCD (liquid crystal display), or LED (Light Emitting Diode) monitor, for displaying information to the user and a keyboard and a pointing device by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The techniques described herein can be implemented in a computing system that includes a back end component, such as a data server, or that includes a middleware component, such as an application server, or that includes a front end component, such as a client computer having a graphical user interface or Web browser through which a user can interact with an implementation of the techniques described here, or any combination of such back end, middleware, or front end components.

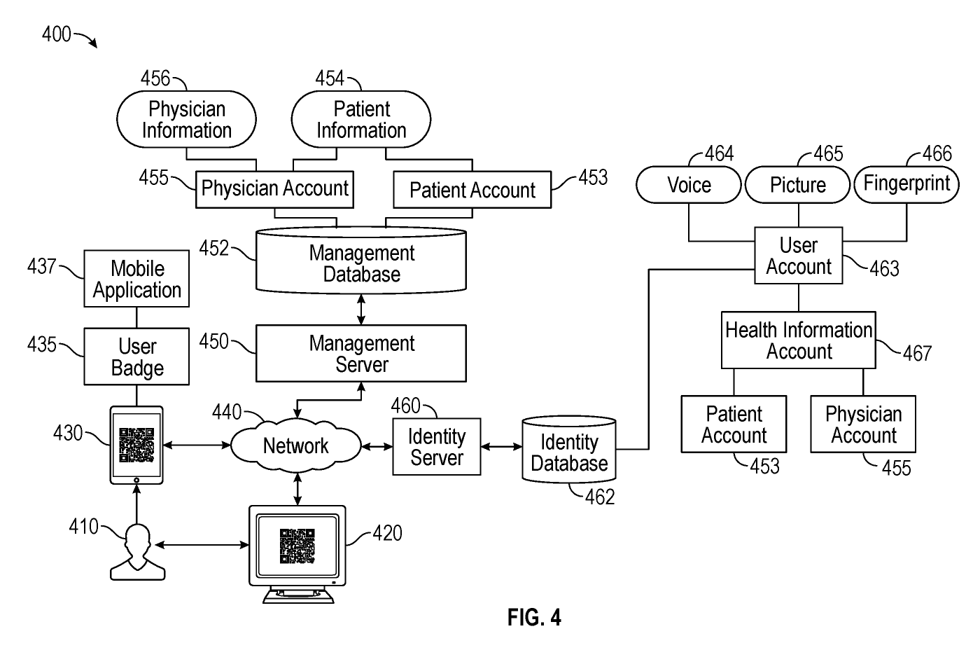

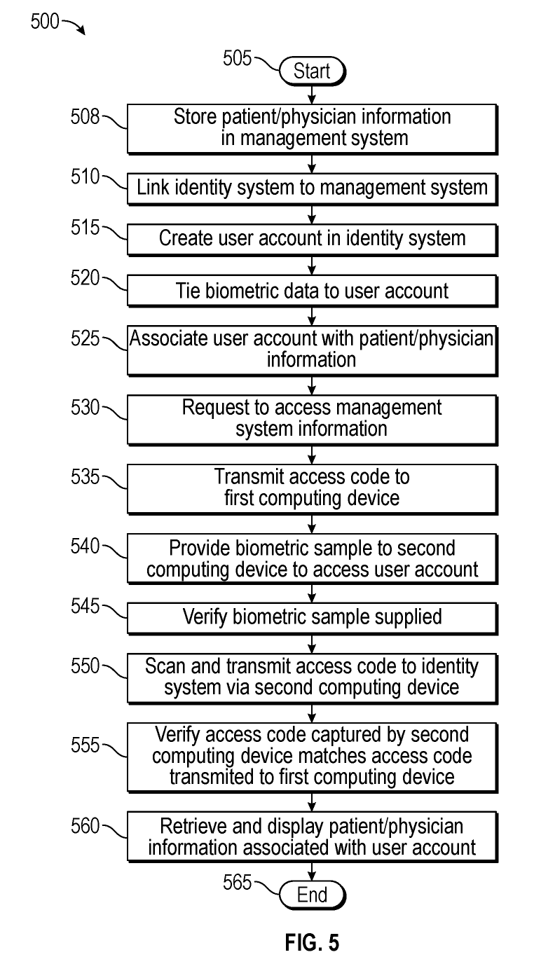

FIGS. 4 and 5 illustrate preferred embodiments of a system and mathod, respectively, for limiting information access based on user identity via biometric authentication. FIG. 5 is a flowchart 500 illustrating various method steps that may be carried out to perform the method of the present disclosure. It is understood that the various method steps associated with the method of the present disclosure may be carried out as operations by the system 400 of the present disclosure.

As shown in FIG. 4, the system 400 of the present disclosure generally comprises a first computing device 420, a second computing device 430, a management system, and an identity system. The management system preferably comprises a management database 452 configured to store information therein and a management server 450 operably connected thereto such that the management server 450 may transmit information to or retrieve information from the management database 452, as shown in FIG. 4. The management server 450 may be operably connected to the first computing device 420 such that the management server 450 may transmit information to or receive information from the first computing device 420. The management server 450 may be further connected to the second computing device 430 in the same or similar manner as the first computing device 420 in some embodiments. As further shown in FIG. 4, the identity system preferably comprises an identity database 462 configured to store user accounts 463 and the information associated with such accounts therein. In a preferred embodiment, the identity database 462 stores biometric data 464-466 acquired from a user 410 therein. The identity system further comprises an identity server 460 operably connected to the identity database 462 such that the identity server 460 may transmit information to or from the identity database 462. The identity server 460 is operably connected to the management server 450 such that information may be communicated from the identity server 460 to the management server 450 or vice versa. The identity server 460 is further operably connected to the second computing device 430 such that information, such as biometric data, may be transmitted from the second computing device 430 to the identity server 460. In some instances, the identity server 460 may be further operably connected to the first computing device 420 in some embodiments. It is understood that where reference is made to two components of the system 400 being operably connected, the present disclosure contemplates embodiments where such components are connected through a wired connection, through a wireless connection such as through a cloud-based network 440, or through a combination thereof

The identity server 460 is configured to perform the various operations disclosed herein based on programming instructions stored within the system 400. The identity server 460 may be any server or combination of multiple servers suitable for executing such programming instructions. In a preferred embodiment, the programming instructions responsible for operations carried out by the identity server 460 are stored on a first non-transitory computer-readable medium that is coupled to the identity server 460. Alternatively, such programming instructions may be stored or included within the identity server 460. Similarly, the management server 450 is configured to perform the various operations disclosed herein based on programming instructions stored within the system 400. The management server 450 may be any server or combination of multiple servers for executing such program instructions. In a preferred embodiment, the programming instructions responsible for operations carried out by the management server 450 are stored on a second non-transitory computer-readable medium that is coupled to the management server 450.

Examples of non-transitory computer-readable mediums include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions for the identity server 460 and/or the management server 450 may be stored as programming modules within the first non-transitory computer-readable medium and/or the second non-transitory computer readable medium, respectively.

As shown in FIG. 4, in a preferred embodiment, the management database 452 is configured to store patient accounts 453 and/or physician accounts 455 and information tied to such accounts therein. Though the management data base 452 is generally referred to as storing patient information 454 and/or physician information 456 therein throughout the present disclosure, it is understood that the management database 452 may store other types of information unrelated to the medical field therein without departing from the inventive subject matter of the present disclosure. Accordingly, though the system 400 and method of the present disclosure are adapted to provide a more secure manner in which patient or physician medical information may be stored and retrieved than what is currently known in the art in some preferred embodiments, one of skill in the art will appreciate that the system 400 and method of the present disclosure may be utilized in any setting where a need for secure data storage and retrieval is needed. The management database 452 may be a relational database. Alternatively, the management database 452 may be an object database. In some instances, the management database 452 may be a data file having patient accounts 453 and/or physician accounts 455 and the information tied thereto, e.g., a digital spreadsheet.

The identity database 462 is configured to store user accounts 463 and the information associated with such accounts therein. As shown in FIG. 4, in a preferred embodiment, each user account 463 is tied to one or more pieces of biometric data acquired from a user 410. Such biometric data may include, but is not limited to, voice-recording data 464 comprising one or more recordings of a user's 410 voice, pictorial data 465 comprising one or more digital pictures or videos of a user's 410 face, fingerprint data 466 comprising one or more fingerprints of a user 410. One of skill in the art will appreciate, however, that any other similar or suitable biometric data, such as retinal scan data, that is unique to a user 410 may be used within the system and method disclosed herein. In another preferred embodiment, the above described biometric data may be stored locally within the second computing device 430.

Each user account 463 within the identity database 462 preferably has a health information account 467 associated therewith or tied thereto, wherein the health information account 467 is a user account stored within the management database 452. In this way, the user account 463 within the identity database 462 is linked to a user account within the management database 452. As shown in FIG. 4, in a preferred embodiment, the health information account 467 is preferably either a patient account 453 or physician account 455. In a preferred embodiment, the user account 463 within the identity database 462 is linked to a user account within the management database 452 via one or more shared data elements associated with each respective account. For instance, a user account 463 within the identity database 462 may be linked to a patient account 453 within the management database 452 via a shared email address associated with or stored within each respective account. However, one of skill in the art will appreciate that other types of information related to a user 410 may serve as the shared data element that links such accounts in the above described manner without departing from the inventive subject matter disclosed herein. Such other types of information may include, but are not limited to, a user's phone number, account or client number, address, or any other type of identifying information that may be associated with a user 410. The identity database 462 may be any type of database suitable for storing the above identified information therein.

In one preferred embodiment, the management system is a patient health information management system that is managed by a healthcare entity, provider, and/or agency. It is understood, however, that other management systems may be used without departing from the inventive subject matter disclosed herein. The management system may have a website associated therewith such that a user 410 may navigate to the management system website via a suitable computing device and subsequently access information stored within the management system once user identity is verified in the manner described herein. In such embodiments, the website associated with the management system may have a plurality of webpages. To navigate through such webpages, a series of links or tabs may be incorporated into one or more of the webpages within the website. The management system may also have an application programming interface associated therewith which may be utilized for managing or expanding upon the applications and/or functionalities carried out by the management system disclosed herein.

In another preferred embodiment, the identity system may have a mobile application 437 associated therewith that may be utilized by a user 410 in various manners and forms described herein. The mobile application 437 is preferably designed and implemented into a mobile computing device such that the mobile application 437 may access and/or utilize certain structural features or functionalities within the mobile computing device, such as a camera or touch identification sensor features. In a preferred embodiment, the mobile application 437 provides an interface through which a user 410 may transmit information from a suitable mobile computing device to the identity server 460. For instance, in some embodiments, a user 410 may provide a biometric sample to the computing device that is subsequently communicated by the computing device to the identity server 460. To implement the mobile application 437 on a mobile computing device, a user 410 may be required to download and install the mobile application onto a desired mobile computing device. To access certain features and/or functionalities of the mobile application 437, such as accessing a camera or scanner feature within mobile application 437, a user 410 may be required to login to the mobile application 437.

As further shown in FIG. 4, the mobile application 437 may have a user badge 435 associated therewith. The user badge 435 preferably has various user 410 information associated therewith, such that the user badge 435 serves to identify the user 410. In a preferred embodiment, the user badge 435 is used to establish the user's 410 identity within the mobile application 437. In a preferred embodiment, each user account 463 within the identity database 462 has a user badge 435 tied thereto or associated therewith. In one preferred embodiment, authentication of a user badge 435 is required before a user 410 can log into the mobile application 437 and access the certain features contained therein. Authentication of a user badge 435 is preferably achieved via biometric authentication carried out by the mobile computing device on which the mobile application 437 is installed. In such embodiments, biometric authentication is preferably achieved by first storing the biometric data of a user 410 within the mobile computing device, acquiring a data sample from the user 410, then comparing the acquired sample to the stored biometric data to determine a match therebetween. In alternative embodiments, a user badge 435 may be authenticated by entering a defined passcode into the mobile computing device.

During a user's 410 first use of the mobile application 437, the user 410 may be required to set up a user badge 435. To set up the user badge 435 such that the user badge 435 is associated with the mobile application 437, a user 410 may be required to create and input a username and/or password into the mobile application 437. However, as authentication of the user badge 435 can subsequently be achieved via biometric authentication, a user 410 can create extremely complex usernames and/or passwords without having to later recall such credential information to login to the mobile application 437. In some instances, a user 410 may be required to be pre-registered with a healthcare provider, agency, or other healthcare entity and input certain information related to their registration to set up a user badge 435. In such embodiments, the registration information inputted by the user 410 may be cross-checked with one or more external records of a healthcare provider, agency, or other healthcare entity to verify the inputted information is accurate.

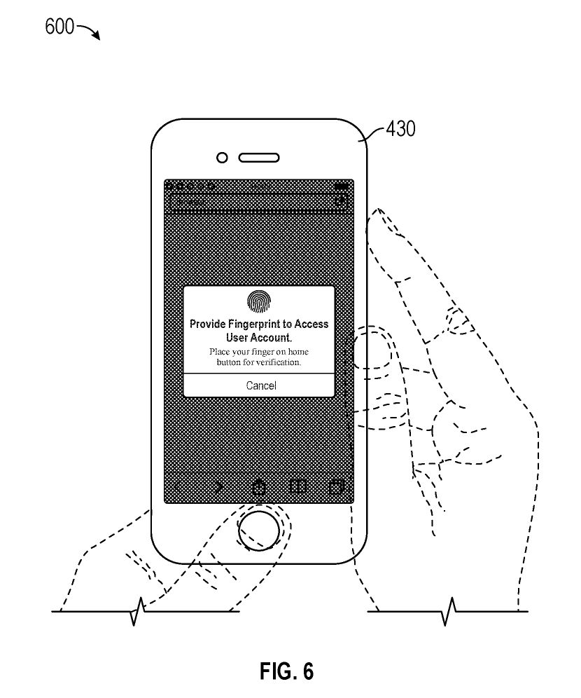

Preferably, once the user badge 435 is set up the mobile application 437 will automatically load the user badge 435 anytime the user 410 accesses the mobile application 437. Once the user badge 435 is loaded the user 410 may be prompted to authenticate the user badge 435 by supplying a biometric sample to the mobile computing device as shown in FIG. 6. In some embodiments, the mobile application 437 may also be in operable communication with one or more components of the management system. The identity system may also have an application programming interface associated therewith that may be utilized for managing or expanding upon the applications and/or functionalities carried out by the identity system disclosed herein.

Although the management system and identity system are represented as separate entities in FIG. 4, it is understood that some or all of the components of the identity system may be incorporated into the management system, or vice versa, in alternative embodiments without departing from the inventive subject matter disclosed herein. In some embodiments, the system 400 may utilize one or more database management systems such as Microsoft SQL, PostgreSQL, or any other similar database management system.

The first computing device 420 may be any computing device suitable for receiving information from the management server 450 and displaying such information to a user 410. Such devices include, but are not limited to, a desktop computer, laptop computer, a workstation, an internet-ready television, mobile telephones, tablet computers, or any other suitable computing device that may be operably connected to the management server 450. In some instances, a digital media player and/or microconsole, such as the Apple TV, may be used in conjunction with the first computing device 420. In such embodiments, the media player/microconsole may receive digital data transmitted from the management system and/or identity server and subsequently transmit such data to the first computing device 420. In some embodiments, such media players/microconsoles may also be used in conjunction with the second computing device 430 in the same manner as with the first computing device 420.

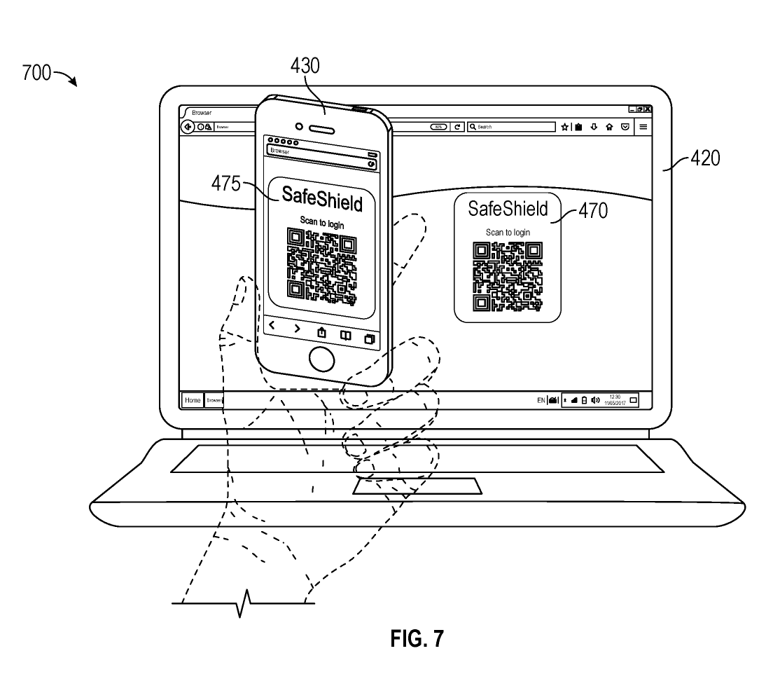

The second computing device 430 may be any computing device suitable for receiving a biometric sample from a user 410 and hosting the mobile application 437 described above. The second computing device 430 may be configured to transmit a biometric sample to the identity server 460. In some instances, the second computing device may be configured to compare a biometric sample provided by a user 410 to biometric data stored within the second computing device 430 to establish a match therebetween. The second computing device 430 is preferably configured to scan an access code 475 in the manner disclosed herein. To scan the access code 475, the second computing device 430 is preferably a computing device having a functional camera built therein. To support fingerprint authentication, in the manner described herein, the second computing device 430 also preferably has a fingerprint recognition feature built or installed therein. To support voice-recording authentication, the second computing device 430 may have a microphone built therein. To facilitate mobility, the second computing device 430 is preferably a mobile computing device such as a mobile telephone, as shown in FIGS. 6-7, or a tablet computer, as shown in FIG. 4.

FIG. 5 provides a flowchart 500 illustrating certain, preferred method steps that may be used to carry out the method of the present disclosure. Step 505 indicates the beginning of the method. In information generation step 508, information associated with a user 410 is stored within the management database 452 within the management system. As best shown in FIG. 4, step 508 may involve creating a user account corresponding to the user 410 and storing the user account within the management database 452. Information associated with the user 410 is tied to the user's 410 user account within the management database 452 such that the user's information may be accessed by accessing the user account within the database. In a preferred embodiment, the user account within the management database 452 may be a patient account 453 or a physician account 455, as shown in FIG. 4. In one preferred embodiment, the management database 452 stores both patient accounts 453 and physician accounts 455 therein.

Patient accounts 453 within the management database 452 correspond to individual patients that are clients of or otherwise associated with a healthcare provider, agency, and/or other healthcare entity. Thus, in some instances, a patient account 453 may be created by registering a user 410 as a patient or creating a patient profile within a patient health information management system associated with the healthcare provider, agency, and/or other healthcare entity. Patient information 454 stored within the management database 452 and tied to a patient account 453 may include, but is not limited to, a user's 410 name, address, phone number, email address, medical history, diagnoses, medication, immunizations records, allergies, radiology images, lab and test results, vital signs, attending physician name and/or licensure number, progress notes, and billing data associated with the user 410.

Similarly, physician accounts 455 within the management database 452 correspond to individual physicians that are employed by or otherwise associated with a healthcare provider, agency, and/or other healthcare entity. In some instances, a physician account 455 may be created within the management database 452 by registering a user 410 as a physician or creating a physician profile within a patient health information management system associated with the healthcare provider, agency, and/or other healthcare entity. Physician information 456 stored within the management database 452 and tied to a physician account 455 may include, but is not limited to, the user's 410 name, address, telephone number, email address, a list of the user's 410 patients, such patients' patient ID or visit number, outstanding administrative duties, and/or work schedule. In one preferred embodiment, physicians may have some or all of the patient information 454 tied to a patient's patient account 453 tied to their physician account 455. In such embodiments, it is generally preferred that patient information 454 tied to a patient's patient account 453 only be tied to physician accounts 455 corresponding to the patient's treating physicians. In some instances, information, such as digital videos, sound recordings, forms, and checklists, may be assigned to a patient account 453 or physician account 455 based on a patient's medical information in the manner disclosed within U.S. patent application Ser. No. 15/582,414 recently filed by the Applicant.

In step 510 the identity system is linked to the management system such that information may be transmitted from the management system to the identity system and vice versa. As shown in FIG. 4, in one preferred embodiment, the management system and identity system are linked by operably connecting the management server 450 to the identity server 460 via a wired or wireless connection.

As shown in FIG. 5, in step 515 a user account 463 is created within the identity system. In a preferred embodiment, a user account 463 may be created by registering a user 410 within the identity database 462 and tying the user account 463 to the user badge 435 associated with the user 410. In some instances, the system 400 may be designed such that only individuals who are already registered with a healthcare provider, agency, or other healthcare entity can create a user account 463. Accordingly, in some embodiments, creating a user account 463 may involve supplying certain defined information to the identity server 460 and the identity server 460 comparing the supplied information to one or more external records of a healthcare provider, agency, or other healthcare entity either stored within the management system or otherwise accessible to the identity server 460. In a preferred embodiment, step 515 may involve registering a user 410 within the identity system via the mobile application 437 associated with the identity system and installed on the second computing device 430. After downloading and installing the mobile application 437, the mobile application 437 may prompt the user 410 to input various personal information into the mobile application. In some instances, user information may be extracted from the user badge 435 and used to create the user account 463.

In some embodiments, the user 410 may be required to create and input a username and/or password in order to create a user account 463. However, as described below, the username and/or password inputted during step 515 is not required for the user 410 to subsequently access their user account 463 within the identity system and carry out the various steps that follow. Accordingly, because the username and/or password is not required for user account 463 access, a user 410 can create a very complicated username or password to initially create a user account 463 without having to later recall this information. In this way, the system 400 and method of the present disclosure may promote users 410 to create complex username/password schemes that are less likely to be compromised during step 515. In alternative embodiments, a user 410 may create a user account 463 within the identity system by navigating to and opening a webpage associated with the identity system and inputting required information to create a user account 463 therein. Once the user has inputted the required information to create a user account 463, the user account 463 is preferably stored within the identity database 462, as shown in FIG. 4, for subsequent access by the identity server 460.

In one preferred embodiment, once a user 410 has established a user account 463 within the identity system, the user 410 may be required to submit certain biometric data to the identity system to be tied with the user's user account 463 in step 520. In some instances, the submission of such biometric data may be required as a precursor to finalizing the creation of a user account 463 within the identity system. As shown in FIG. 4, biometric data required for user submission may include, but is not limited to, one or more voice recordings 464, one or more pictures or video 465 of a user's 410 facial region or other bodily region, or one or more fingerprints 466. However, one of skill in the art will appreciate any suitable biometric data may be utilized for the purposes disclosed herein without departing from the inventive subject matter of the present disclosure. In one preferred embodiment, the user 410 may be required to submit only fingerprint data 466 to the identity system. Alternatively, the user 410 may be required to submit multiple types of biometric data to the identity system.

Users 410 preferably submit biometric data to the identity system via the second computing device 430. For instance, to submit a voice recording, the user 410 may utilize a microphone built into the second computing device 430 to capture a recording of the user's 410 voice. To submit pictorial data such as a photograph or video, the user 410 may utilize a camera built into the second computing device 430 to take a picture or video of the user 410. To submit fingerprint data, the user 410 may utilize a touch sensor built into the second computing device 430 configured to read and store user 410 fingerprints to record the user's 410 fingerprint. Upon inputting biometric data, the second computing device 430 may transmit the biometric data to the identity server 460. Upon receiving the biometric data, the identity server 460 preferably transmits the biometric data to the identity database 462 and ties the biometric data to the appropriate user account 463 contained therein. One of skill in the art will readily appreciate, however, that the devices used and manner in which biometric data is tied to a user account 463 may vary from that described above without departing from the inventive subject matter of the present disclosure.

In another preferred embodiment, the above describe biometric data 464-466 may be stored locally within the second computing device 430 rather than within the identity system. Accordingly, in some embodiments, a user 410 may be required to submit certain biometric data into the second computing device 430. The user 410 may submit biometric data to the second computing device 430 utilizing certain features and/or structural components within the second computing device 430 in the manner described above, e.g., utilizing a touch sensor pad within the second computing device 430 to read the user's 410 fingerprint. Once the user 410 has inputted the required biometric data into the second computing device 430, the second computing device 430 stores the biometric data such that the data can be retrieved for later use. For improved security, such biometric data may be stored within a tamperproof integrated circuit within the second computing device 430. Alternatively, the biometric data may be stored within memory associated with the second computing device 430 or within a database accessible to the second computing device.

As shown in FIGS. 4-5, the user account 463 within the identity system is associated with a user account within the management system in step 525 in the manner described above using one or more data elements shared between the two accounts. In a preferred embodiment, the user account 463 within the identity system has a health information account 467 tied thereto, as shown in FIG. 4. As further shown in FIG. 4, the health information account 467 is preferably either the patient account 453 or the physician account 455 within the management database.

In information request step 530, a user 410 requests to access information stored within the management database 452 by navigating to a webpage associated with the management system, such as a management system login page, via the first computing device 420. In alternative embodiments, a user 410 may navigate to a webpage associated with the management system using the second computing device 430. Upon such user request, an access code 470 as shown in FIG. 7 is transmitted to the first computing device 420 in access code transmission step 535. In a preferred embodiment, step 535 involves the management server 450 first transmitting an access code request to the identity server 460. Upon receiving the request, the identity server 460 generates and subsequently transmits an access code 470 and a session ID to the management server 450. The management server 450 then transmits the access code 470 to the first computing device 420 such that the access code 470 is visible to the user 410, as shown best in FIG. 7. In a preferred embodiment, the access code 470 is a matrix bar code, such as a quick response (QR) code. In some embodiments, upon receiving an access code request, the identity server 460 generates and subsequently transmits a QR code string to the management server 450. The QR code string is received by the management server 450 and subsequently rendered as a two-dimensional bar code on the first computing device 420. The two-dimensional bar code may be displayed within a webpage associated with the identity system. Generating the access code and transmitting it between the identity server 460, the management server 450, and the first computing device 420 in this way may serve to prevent the access code from being intercepted by an unauthorized device. In alternative embodiments, the identity server 460 may transmit the access code 470 directly to the first computing device 420 after generating the access code 470. Once transmitted to the first computing device 420, the access code 470 is ready to be scanned in the manner described herein.

In a preferred embodiment, the identity system verifies the user's 410 identity prior to the user 410 scanning the access code 470. In a preferred embodiment, a user cannot access the camera of the second computing device 430 within the mobile application 437 prior to having their identity verified in the manner described below.

To verify user 410 identity, the user 410 provides a biometric sample to the second computing device 430. The type of biometric sample required to be inputted into the second computing device depends on the type of biometric data either stored locally on the second computing device 430 or stored within the identity database 462. For instance, if the biometric data stored within the second computing device 430 or the identity database 462 is pictorial data 465, the user 410 may be required to take a picture of his or her face using the camera of the second computing device 430. In one preferred embodiment, the biometric data stored within the second computing device 430 or the identity database 462 is fingerprint data 466. In such embodiments, the user is required to provide a fingerprint sample to the second computing device 430. FIG. 6 shows a diagram 600 of a user 410 providing a fingerprint sample to the second computing device 430. As shown in FIG. 6, to provide a fingerprint sample, the user engages a touch ID sensor present on a button of the second computing device 430. However, it is understood that the location of such touch ID sensor may vary depending on the nature of the second computing device 430. As further shown in FIG. 6, the second computing device 430 may prompt the user 410 to provide the required biometric sample using one or more text or image based prompts generated by the mobile application 437. In a preferred embodiment, the user is required to provide only one biometric sample during step 540. Alternatively, the user may be required to provide multiple biometric samples.

Once the user 410 has provided a biometric sample to the second computing device 430, the biometric sample is compared to the biometric data stored within either the second computing device 430 or the identity server 460 to determine a match therebetween in verification step 545. In one preferred embodiment, the biometric data acquired form the user 410 is stored within the second computing device 430 and step 545 is carried out by the second computing device 430. In such embodiments, the second computing device 430 retrieves the stored biometric data and compares that data to the biometric sample provided by the user 410. If the second computing device 430 determines that the biometric sample matches the biometric data stored therein, the second computing device 430 signals that the user's 410 identity has been verified and the identity server 460 grants the user 410 access to the user account 463 within the identity system via the second computing device 430.

In some instances, the user 410 is granted access to the user account 463 by being permitted to log into or being automatically logged into the mobile application 437 associated with the identity system. In such embodiments, upon the second computing device 430 verifying the biometric sample provided by the user, the user's 410 user badge 435 is authenticated and the mobile application 437 requests an identity code from the management server 450, which subsequently requests an identity code from the identity server 460. Upon such request, the identity server 460 generates an identity code and subsequently transmits the code to the management server 450. In a preferred embodiment the identity code is a QR code string. Once the identity code is received by the management server 450, the management server 450 sends the identity code to the mobile application 437 on the second computing device 430. After the identity code is received by the mobile application 437 on the second computing device 430, the mobile application 437 transmits the identity code with the user's 410 user badge 435 or the information associated therewith to the identity server 462.

Based on the user badge 435 associated with the transmitted identity code, the identity server 460 determines which user account 463 within the identity database 462, and thus which user 410, is using the identity code. If the identity server 460 determines a user 410 associated with a user account 463 within the identity database 462 is using the identity code, the identity server 460 will identify the user as an authorized user permitted to access the information contained within the user account within the management database 452 associated with the user account 463 of the user 410 within the identity database 462. If the identity server 462 does not find that the user 410 is an authorized user, the mobile application 437 may prompt the user 410 to submit a new biometric sample to the second computing device 430.

In another preferred embodiment, the biometric data acquired from a user 410 is stored within the identity database 462 and tied to the user account 463, and step 545 is carried out by the identity server 460. In such embodiments, the biometric sample supplied by the user to the second computing device 430 is subsequently transmitted by the second computing device 430 to the identity server 460. Once the biometric sample is received by the identity server 460, the identity server 460 verifies the user's 410 identity by comparing the biometric sample to the biometric data tied to the user account 463 associated with the user in the identity database 462. If the identity server 460 determines that the biometric sample matches one or more pieces of biometric data associated with the user account 463, then the identity server 460 verifies the user's 410 identity. Upon verifying the user's 410 identity, the identity server 460 may identify the user 410 as an authorized user that is permitted to access the information contained within the user account within the management database 452 associated with the user account 463 of the user 410 within the identity database 462.

Once a user's identity has been verified, either by the second computing device 430 or by the identity server 460, the user 410 may access the camera of the second computing device 430 within the mobile application 437. FIG. 7 provides a diagram 700 of a user 410 scanning an access code 470. As shown in FIG. 7, the user 410 uses the camera within the second computing device 430 in step 550 to scan the access code 470 displayed on the first computing device 420, thereby creating a scanned code 475. In one preferred embodiment, the scanned code 475 is an image of the access code captured by the second computing device 430. The second computing device 430 subsequently transmits the scanned code 475 to the identity server 460, which compares the scanned code 475 to the access code 470 displayed on the first computing device to determine if the two codes match in step 555. In a preferred embodiment, the scanned code 475 may be processed by the second computing device 430 such that the second computing device reconstructs the scanned code 475 to the form in which the access code 470 was originally generated by the identity server, e.g., a QR code string, prior to transmitting the scanned code 475 to the identity server 460.

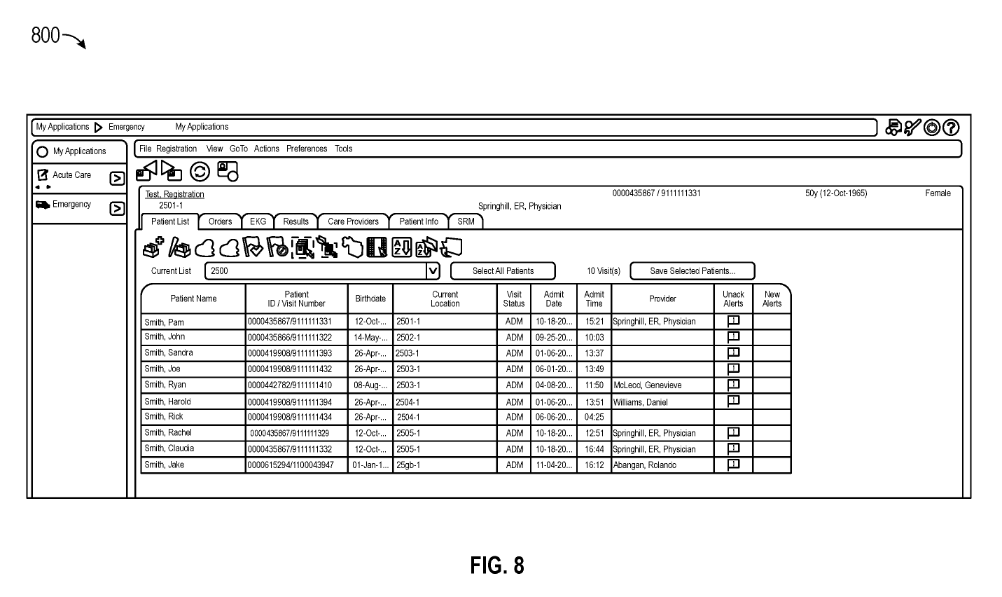

If the identity server 460 determines that the scanned code 475 matches the access code 470 transmitted to the first computing device 420, in step 560 the management server 450 is signaled to retrieve information tied to the user account within the management database 452 associated with the user account 463 of the user 410 verified in step 545 within the identity database 462. For instance, if the user account 463 within the identity database 462 is associated with a physician account 455 within the management database 452, the management server 450 will retrieve any physician information 456 and patient information 454 tied to the physician account 455 and subsequently output such information. Similarly, if the user account 463 is associated with a patient account 453 within the management database 452, the management server 450 will retrieve any patient information 454 tied to the patient account 453 and subsequently output such information. Conversely, if the identity server 460 determines the access code 470 and the scanned code 475 do not match, the management server 450 will not retrieve any information from the management database 452, and the user 410 may be prompted to re-scan the access code 470. In a preferred embodiment, information outputted during step 560 is outputted to the first computing device 420. As shown by the example webpage 800 in FIG. 8, the management server 450 may output retrieved information by navigating the user 410 to a webpage associated with the management system containing such information. In one preferred embodiment, the management server 450 may be configured to generate a report indicating that information from within the management database 452 has been outputted or accessed by a user 410.

In a preferred embodiment, prior to retrieving information from the management database 452, the management server 450 may periodically transmit a request to the identity server 460 inquiring whether the access code 470 transmitted to the first computing device 420 has been scanned. Such requests may be transmitted by the management server 450 at defined time intervals, such as thirty-second time intervals. If the access code 470 has not been scanned the identity server 460 may respond with a signal indicating the same. In some embodiments, a new access code may be generated and subsequently transmitted to the first computing device 420 if an access code is not scanned within a defined period of time. Once such a request is received from the management server 450 and the access code 470 has been scanned in the manner described herein, the identity server 460 transmits a signal indicating the same to the management server 450. In one preferred embodiment, the identity server 460 transmits an access token to the management server 450 indicating that the access code 470 has been scanned.

Upon receiving the access token, the management server 450 may transmit a request to the identity server 460 asking for the identity of the user 410 who scanned the access code 470. The identity server 460 identifies the user 410 and user account 463 based on the information obtained in step 545. If the identified user 410 is an authorized user, as described herein, then user's identity and corresponding user account 463 information is transmitted to the management server 450, which uses such information to retrieve appropriate information from the management database 452. If the user 410 is not an authorized user, identity server 460 may transmit a signal indicating the same to the management server 450, thereby preventing the management server 450 from retrieving information from the management database 452. Step 565 indicates the end of the method. One of skill in the art will appreciate that the above described method steps and operations, in whole or in part, may be utilized to restrict the manner in which information may be stored within the management system. For instance, to store information within the management database 452 a user may be required to submit a biometric sample and scan an access code in the same or similar fashion as described above.

In another aspect, the principles of the present disclosure may be utilized, in full or in part, in a system and method designed to ensure that only authorized users are permitted access to or obtain medical information from a medical device. In such implementations, a medical device may be operably connected to some or all of the components of the system 400 disclosed above via a wired or wireless connection. Systems and methods utilizing the inventive principles disclosed herein for application with a medical device may require the medical device have an access code associated therewith. The access code may be displayed on a display of the medical device or, alternatively, on the housing or other structural components of the medical device. Prior to scanning the access code associated with the medical device, a user may be required to verify their identity through biometric authentication in the manner described above. Once the user's identity is verified, the user may be permitted to scan the access code associated with the medical device. In a preferred embodiment, the user may scan the access code using the second computing device described above. Once the user's identity and the scanned access code are verified, the medical device may be prompted to transmit medical information stored thereon to a computing device, such as the first or second computing device, to be displayed thereon or to a management system for storage therein.

In addition to securely storing and limiting access to information stored within a medical device, the principles of the present disclosure may be utilized to guard against the unauthorized manipulation or alteration of a medical device. For instance, to change the settings of a medical device, such as an intravenous pump, a user may be required to unlock the device. To unlock the device, a user may have to provide a biometric sample and/or scan the access code associated with the device in the same or similar manner as disclosed above.

Although the system and method of the present disclosure has been discussed for use within the medical field, one of skill in the art will appreciate the inventive subject matter disclosed herein may be utilized in other fields or for other applications in which the automated content assignment or management is needed.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method steps which have been described and illustrated in order to explain the nature of this inventive subject matter can be made without departing from the principles and scope of the inventive subject matter.

What is claimed is:

1) A method for biometric authentication, said method comprising the steps of:
storing a piece of information within a management system, wherein the piece of information is tied to a first user account within the management system, and wherein the first user account is associated with a user;
creating a second user account within an identity system, wherein the second user account has the first user account associated therewith;
generating, by the identity system, an access code;
transmitting the access code to a first computing device;
storing biometric data acquired from the user within a storage device;
providing, by the user, a biometric sample to a second computing device, wherein the second computing device is operably connected to the identity system, and wherein the second computing device has a camera therein;
comparing the biometric sample to the biometric data stored within the storage device to determine a match therebetween;
granting, by the identity system, the user access to the second user account via the second computing device once a match between the biometric sample and the biometric data stored within the storage device is determined;
scanning, by the user via the camera of the second computing device, the access code to create a scanned code;
transmitting, by the second computing device to the identity system, the scanned code;
comparing, by the identity system, the scanned code to the access code transmitted to the first computing device to determine a match therebetween;
retrieving, by the management system, the piece of information tied to the first user account; and
outputting, by the management system, the piece of information.

2) The method of claim 1, wherein the storage device is the second computing device, and wherein the step of comparing the biometric sample to the biometric data stored within the storage device to determine a match therebetween is carried out by the second computing device.

3) The method of claim 1, wherein the storage device is the identity system, and wherein the biometric data is tied to the second user account, wherein the step of comparing the biometric sample to the biometric data stored within the storage device to determine a match therebetween is carried out by the identity system, and further comprising the step of:
transmitting, by the second computing device to the identity system, the biometric sample.

4) The method of claim 1, wherein the biometric data is selected from the group consisting of pictorial data, voice-recording data, fingerprint data, and combinations thereof.

5) The method of claim 1, further comprising the steps of:
generating, by the management system, a report indicating the piece of information has been outputted to the user.

6) The method of claim 1, wherein the management system is operably connected to the first computing device, and wherein the step of outputting, by the management system, the piece of information comprises:
transmitting, by the management system, the piece of information to the first computing device.

7) The method of claim 1, further comprising the step of:
transmitting, by the identity system, the access code to the management system, wherein the management system is operably connected to the first computing device, and wherein the step of transmitting the access code to the first computing device is carried out by the management system.

8) The method of claim 1, wherein the access code is a matrix bar code.

9) The method of claim 8, wherein the access code is a quick response code.

10) A method for biometric authentication, said method comprising the steps of:
storing patient medical information within a management system, wherein the patient medical information is tied to a patient account within the management system;
storing physician information within the management system, wherein the physician information is tied to a physician account within the management system;
creating a user account within an identity system, wherein the user account has a health information account tied thereto, wherein the health information account is selected from the group consisting of the physician account and the patient account;
generating, by the identity system, an access code;
transmitting, by the identity system, the access code to the management system;
transmitting, by the management system, the access code to a first computing device operably connected to the identity system and the management system;
storing, in a second computing device, biometric data acquired from the user, wherein the second computing device is operably connected to the identity system and has a camera therein;
providing, by the user, a biometric sample to the second computing device;
comparing, by the second computing device, the biometric sample to the biometric data stored within the second computing device to determine a match therebetween;
granting, by the identity system, the user access to the user account via the second computing device once a match between the biometric sample and the biometric data stored within the second computing device is determined;
scanning, by the user via the camera of the second computing device, the access code to create a scanned code;
transmitting, by the second computing device to the identity system, the scanned code;
comparing, by the identity system, the scanned code to the access code transmitted to the first computing device to determine a match therebetween;
retrieving, by the management system, information tied to the health information account; and
outputting, by the management system, the retrieved information.

11) The method of claim 10, wherein the health information account is the patient account, and
wherein the step of retrieving, by the management system, information tied to the account associated with the health information account comprises:
retrieving the patient medical information tied to the patient account, and
wherein the step of outputting, by the management system, the retrieved information comprises:
outputting the patient medical information.

12) The method of claim 10, wherein the health information account is the physician account, and
wherein the step of retrieving, by the management system, information tied to the account associated with the health information account comprises:
retrieving the physician information tied to the physician account, and
wherein the step of outputting, by the management system, the retrieved information comprises:
outputting the physician information.

13) The method of claim 12, wherein the patient medical information is further tied to the physician account within the management system, and
wherein the step of retrieving, by the management system, information tied to the account associated with the health information account further comprises:
retrieving the patient medical information, and
wherein the step of outputting, by the management system, the retrieved information further comprises:
outputting the patient medical information.

14) The method of claim 10, wherein the biometric data is selected from the group consisting of pictorial data, voice-recording data, fingerprint data, and combinations thereof.

15) The method of claim 10, wherein the management system is operably connected to the first computing device, and wherein the step of outputting, by the management system, the retrieved information comprises:
transmitting, by the management system, the retrieved information to the first computing device.

16) The method of claim 10, wherein the access code is a matrix bar code.

17) The method of claim 16, wherein the access code is a quick response code.

18) A system for biometric authentication, said system comprising:
a management system comprising:
a management database configured to store a first user account therein, wherein the first user account has a piece of information tied thereto; and
a management server configured to transmit information to and from the management database;
a first computing device operably connected to the management server;
a second computing device having a camera therein and biometric data acquired from a user stored therein,
wherein the second computing device is configured to compare a biometric sample provided by the user to the biometric data stored therein to determine a match therebetween; and
an identity system comprising:
an identity database configured to store a second user account therein, wherein the second user account has the first user account associated therewith;
an identity server operably connected to the management database, the first computing device, and the second computing device, wherein the identity server is configured to transmit information to and from the identity database;
a first non-transitory computer-readable medium coupled to the identity server having instructions stored thereon, which, when executed by the identity server, causes the identity server to perform operations comprising:
generating an access code;
transmitting the access code to the management system;
comparing a scanned code to the access code to determine a match therebetween;
a second non-transitory computer-readable medium coupled to the management server having instructions stored thereon, which when executed by the management server, cause the management server to perform operations comprising:
transmitting the access code to the first computing device;
retrieving the piece of information tied to the first user account; and
outputting the piece of information.

19) The system of claim 18, wherein the biometric data is selected from the group consisting of pictorial data, voice-recording data, fingerprint data, and combinations thereof.

20) The system of claim 18, wherein the operation of outputting, by the identity server, the piece of information comprises:
transmitting, by the management server, the piece of information to the first computing device.
